(19) United States
(12) Patent Application Publication
(10) Pub. No.: US 2005/0243256 A1
(43) Pub. Date: Nov. 3, 2005

(54) Fringe field switching mode liquid crystal display device

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/120,529

(22) Filed: May 2, 2005

(30) Foreign Application Priority Data
Apr. 30, 2004 (TW) 93112186

(51) Int. Cl. G02F 1/1343

(52) U.S. Cl. 349/141

(57) ABSTRACT

A fringe field switching liquid crystal display device (200) includes: a first and a second substrates (210, 230) disposed opposite to each other and spaced apart a predetermined distance; a liquid crystal layer (250) interposed between the first and second substrates; a plurality of gate lines (270) and data lines (280) formed on the second substrate, thereby defining a plurality of pixel regions; a plurality of pixel electrodes (233) and a plate-like common electrode (231) provided in each of the pixel regions; and at least an alignment film (214, 234) disposed at one of the substrates adjacent to the liquid crystal layer. The alignment film defines two aligning directions in each pixel region. Liquid crystal molecules in the FFS-LCD device are aligned in different aligning directions as induced by the alignment films, so as to reduce color shift.

### FIELD OF THE INVENTION

The present invention relates to liquid crystal display (LCD) devices, and particularly to a fringe field switching (FFS) mode LCD device with wide viewing angle.

### BACKGROUND

LCD devices are used as displays on a variety of devices such as, for example, computer monitors and motor vehicle cruise control panels. Existing LCD types include, for example, the twisted nematic liquid crystal display (TN-LCD) and the in-plane switching liquid crystal display (IPS-LCD). The TN-LCD often has the problem of a narrow viewing angle, and so the IPS-LCD was developed to overcome this disadvantage. The IPS-LCD typically has one or more common electrodes and a plurality of pixel electrodes all disposed on one of two opposite substrates. The electrodes drive liquid crystal molecules interposed between the substrates with an electric field. The resulting electric field is substantially in a plane parallel to the substrates. Such a configuration provides a wide viewing angle.

However, the common electrodes and pixel electrodes are formed of opaque metals, giving the IPS-LCD a low aperture ratio and low transmittance. Thus, a fringe field switching liquid crystal display (FFS-LCD) with a flat plate-like common electrode has been developed in order to improve on the aperture ratio and transmittance. The FFS-LCD is characterized by its driving electric field, which is between each pixel electrode and the common electrode. Because the common electrode is transparent, the FFS-LCD can typically attain a higher aperture ratio and a higher transmittance.

FIG. 6 is a schematic, cross-sectional view of part of a conventional FFS-LCD. The FFS-LCD 10 includes an upper substrate 11 and an opposite lower substrate 13, with the substrates 11, 13 being spaced apart a predetermined distance. A liquid crystal layer 15 having a multiplicity of liquid crystal molecules (not labeled) is disposed between the upper and lower substrates 11, 13. A backlight module (not shown) is disposed under the lower substrate 13 for providing illumination.

A common electrode 17 and a plurality of pixel electrodes 18 are disposed at the lower substrate 13, with an insulating layer 16 interposed between the common electrode 17 and the pixel electrodes 18. A lower alignment film 19 is formed on the insulating layer 16, such that the lower alignment film 19 also covers the pixel electrodes 18. A color filter 12 and an upper alignment film 29 are formed on an inner surface of the upper substrate 11, in that order from top to bottom.

Also referring to FIG. 7, two gate lines 3 and two data lines 5 define a pixel area of the FFS-LCD 10. The data lines 5 are parallel to but spaced apart from each other, and are substantially perpendicular to the gate lines 3.

A pixel electrode 18 and a common electrode 17 are formed in the pixel area. The pixel and common electrodes 18, 17 are made of a transparent conductive material such as indium-tin-oxide (ITO) or indium-zinc-oxide (IZO). The pixel electrode 18 includes a plurality of comb tooth portions (not labeled) substantially parallel to each other, and is electrically connected to a source line 9 of a TFT (not labeled) through a contact hole thereof.

The comb tooth portions of the pixel electrode 18 are parallel to each other, and are all oriented in a first direction. When the FFS-LCD 1 is driven, a fringe electric field is formed between the common electrode 17 and the pixel electrode 18. The liquid crystal molecules disposed over the common electrode 17 and pixel electrodes 18 are driven by this electric field and have a corresponding orientation. This means that the liquid crystal molecules are rotated only in a single direction. Consequently, an associated display screen exhibits color shift when the display screen is obliquely viewed while displaying white.

Referring to FIG. 8, a schematic, plan view of a pixel area of another conventional FFS-LCD is shown. Comb tooth portions of a pixel electrode 28 are substantially parallel to each other. Each comb tooth portion has an elbow section, such that the comb tooth portion is rectilinearly bent. When a voltage is applied between pixel and common electrodes 28, 27, a horizontal in-plane electric field in two directions is established between the pixel and common electrodes 28, 27. Thus, the liquid crystal display device has two domains so as to reduce color shift.

However, when no voltage is applied between the pixel and common electrodes 28, 27 (i.e., when the pixel area is in an off state), long axes of all the liquid crystal molecules in the pixel area maintain a predetermined angle as induced by the alignment film (not shown). All the liquid crystal molecules in this pixel area are aligned only in a single direction. This means that, in the off state, an associated display screen is liable to exhibit color shift when the display screen is obliquely viewed while displaying white. That is, the viewing angle is reduced.

What is needed, therefore, is a fringe field switching mode liquid crystal display device which has reduced color shift and which provides relatively uniform display quality.

### SUMMARY

A fringe field switching liquid crystal display device includes a first and a second substrates disposed opposite to each other and spaced apart a predetermined distance, a liquid crystal layer interposed between the first and second substrates, a plurality of gate lines and data lines formed on the second substrate, thereby defining a plurality of pixel regions, a plurality of pixel electrodes and a plate-like common electrode provided in each of the pixel regions, and at least an alignment film disposed at one of the substrates adjacent to the liquid crystal layer. The alignment film defines two aligning directions in each pixel region.

The FFS-LCD employs an alignment film defining two aligning directions in each pixel region. Therefore when the FFS-LCD is in an offstate (i.e., when no voltage is applied between the pixel and common electrodes), the liquid crystal molecules in each pixel region still maintain two directions according to the aligning directions of the alignment film. This reduces color shift and increases the viewing angle.

Other objects, advantages, and novel features of preferred embodiments will become more apparent from the following detailed description when taken in conjunction with the accompanying drawings.

### BRIEF DESCRIPTION OF THE DRAWINGS

FIG. 1 is a schematic, side cross-sectional view of part of an FFS-LCD device according to a first embodiment of the present invention, shown when a voltage is applied thereto.

FIG. 2 is a top plan view of a configuration of electrodes in a pixel region of the FFS-LCD device of FIG. 1.

FIG. 3 is an enlarged, schematic view of pixel electrodes of the pixel region of FIG. 2, showing orientations of liquid crystal molecules when no voltage is applied to the electrodes.

FIG. 4 is similar to FIG. 3, but showing changed orientations of the liquid crystal molecules when a voltage is applied to the electrodes.

FIG. 5 is a top plan view of pixel electrodes of a pixel region of an FFS-LCD device according to a second embodiment of the present invention, showing orientations of liquid crystal molecules when no voltage is applied to the electrodes.

FIG. 6 is a schematic, side cross-sectional view of part of a conventional FFS-LCD device.

FIG. 7 is a top plan view of a configuration of electrodes in a pixel area of the FFS-LCD device of FIG. 6.

FIG. 8 is a top plan view of a configuration of electrodes in a pixel area of another conventional FFS-LCD device.

### DETAILED DESCRIPTION OF PREFERRED EMBODIMENTS

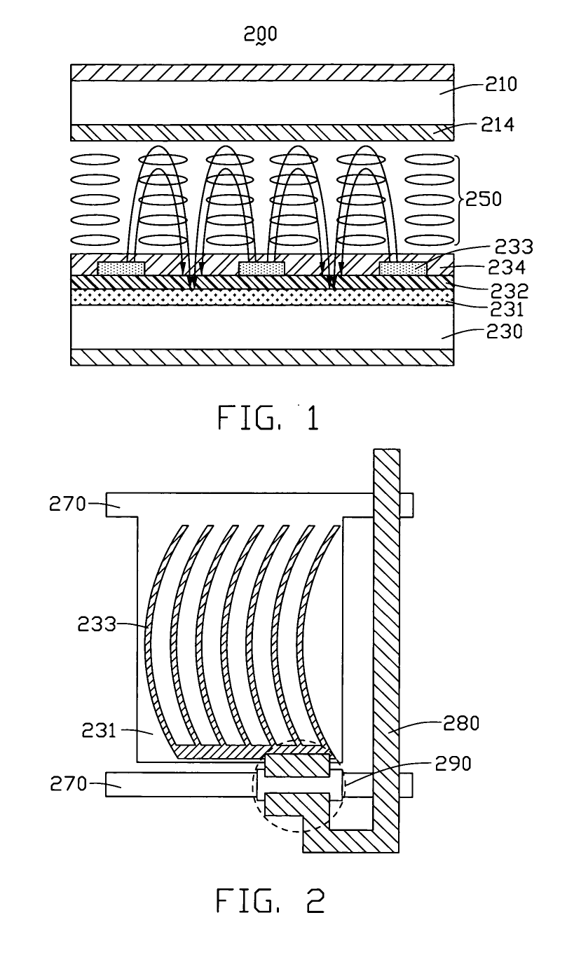

FIG. 1 is a schematic, side cross-sectional view of part of an FFS-LCD device 200 according to a first embodiment of the present invention, shown when a voltage is applied thereto. The FFS-LCD device 200 includes a transparent first substrate 210, a transparent second substrate 230, and a liquid crystal layer 250 sandwiched between the first and second substrates 210, 230.

An alignment film 214 is coated on an inner surface of the first substrate 210 that is opposite to the second substrate 230.

A common electrode 231 is directly formed on an inner surface of the second substrate 230, and an insulating layer 232 is formed on the common electrode 231. Pixel electrodes 233 are directly formed on a surface of the insulating layer 232, and an alignment film 234 is formed on the pixel electrodes 233 such that it also covers the insulating layer 232. The liquid crystal layer 250 is sandwiched directly between the alignment films 214, 234.

Also referring to FIG. 2, two parallel gate lines 270 orthogonally cross a data line 280, thereby defining a rectangular pixel region. A TFT device 290, a plate-like common electrode 231, and a plurality of pixel electrodes 233 are provided in the pixel region. The alignment films 214, 234 cooperatively define two different aligning directions in each pixel region, and the two aligning directions are substantially perpendicular to each other.

The pixel and common electrodes 233, 231 are made of a transparent conductive material such as indium-tin-oxide (ITO) or indium-zinc-oxide (IZO). The pixel electrodes 233 share a common central wiring (not labeled) connecting to a drain electrode (not labeled) of the TFT device 290, the wiring being disposed essentially parallel to the gate lines 270. The pixel electrodes 233 are substantially a plurality of curved comb tooth portions extending from the wiring. In the illustrated embodiment, the curved comb tooth portions are arcuate.

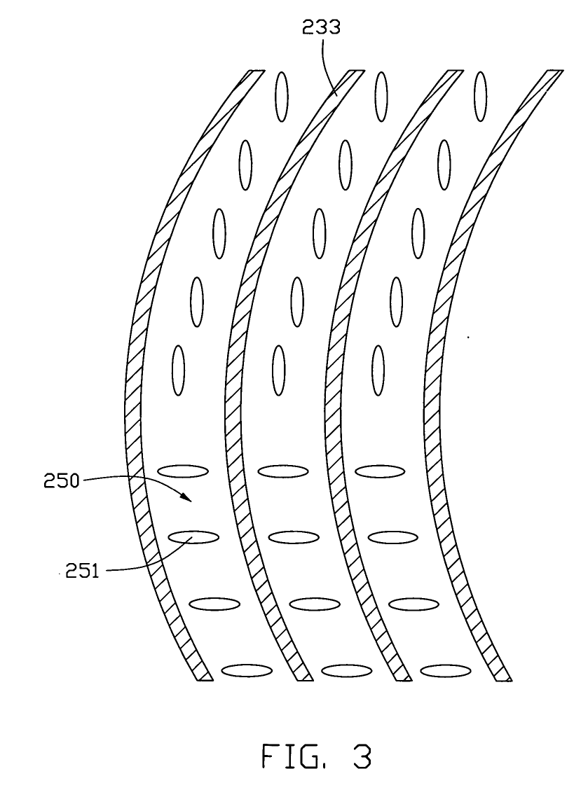

Referring to FIG. 3, in an off state (i.e., when no voltage is applied to the FFS-LCD device 200), the liquid crystal molecules 251 contained in the liquid crystal layer 250 align in two different directions as induced by the alignment films 214, 234. Accordingly, the liquid crystal molecules 251 in the liquid crystal layer 250 are twisted in two substantially perpendicular directions so as to compensate for each other in each pixel region, thereby reducing color shift in the off state.

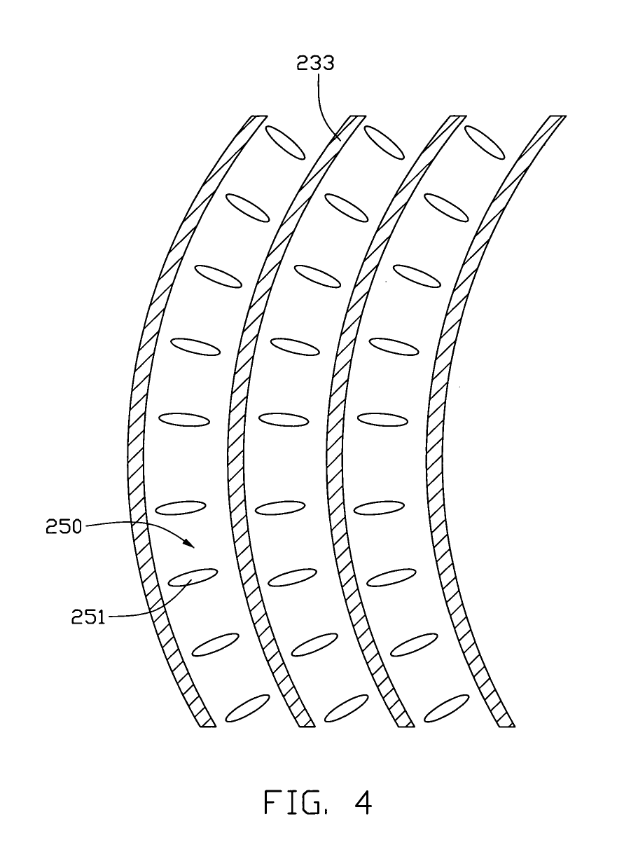

On the other hand, referring to FIG. 4, when a common voltage is applied to the common electrodes 231, and another different voltage is applied to the pixel electrodes 233, a horizontal electric field in different directions is thereby established. The electric field is oriented in successive contiguous directions that continuously vary. The electric field causes liquid crystal molecules 251 in the liquid crystal layer 250 to be twisted in a plane that is parallel to the substrates 210, 230, for controlling a corresponding display.

According to the configuration of the common and pixel electrodes 231, 233, an electric field is generated in different directions, so as to form a continuous domain in spaces defined between the common and pixel electrodes 231, 233. Accordingly, the liquid crystal molecules 251 in the liquid crystal layer 250 are twisted in different directions in a gradually changing continuum.

As a result, no matter whether the FFS-LCD device 200 is in an off state or an on state, different colors can be seen in two regions of the display screen corresponding to said continuous domain in said spaces. The colors compensate for each other, thereby reducing color shift.

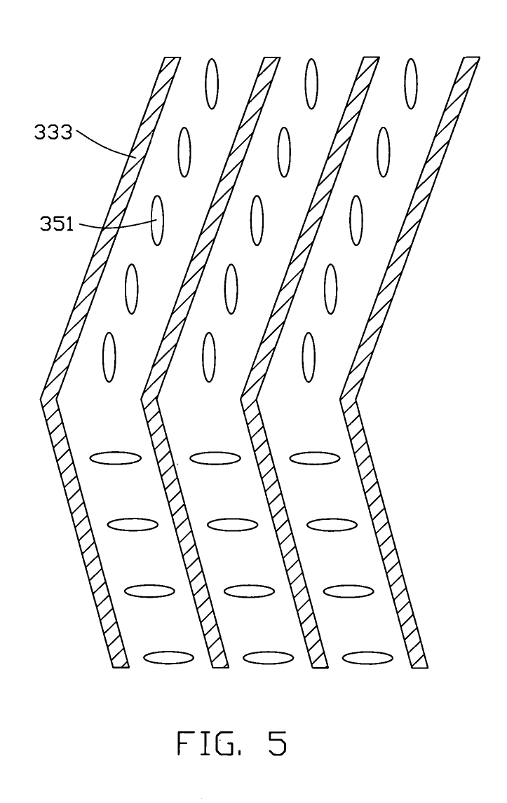

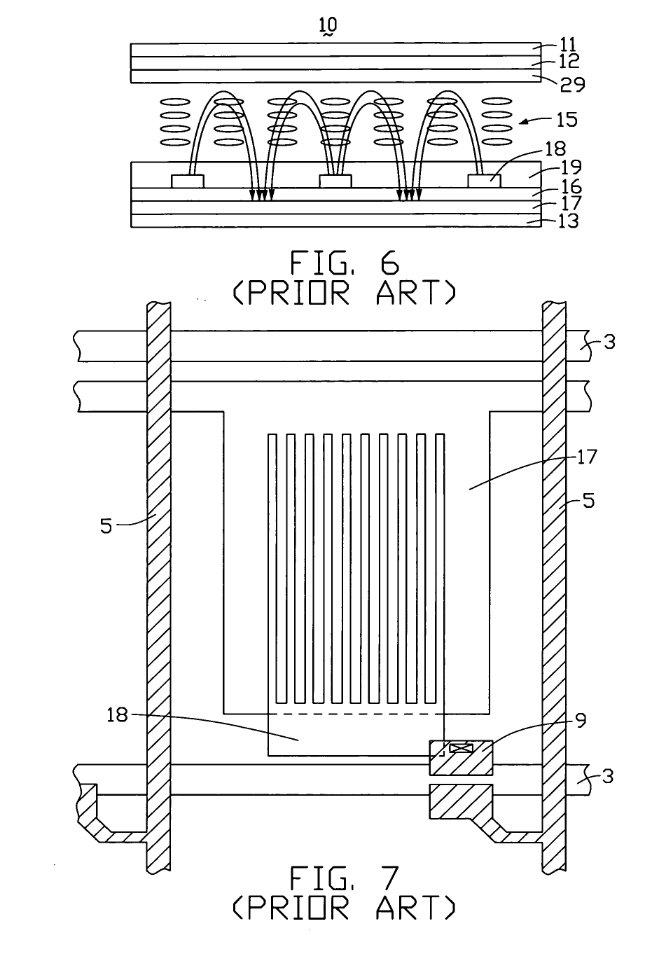

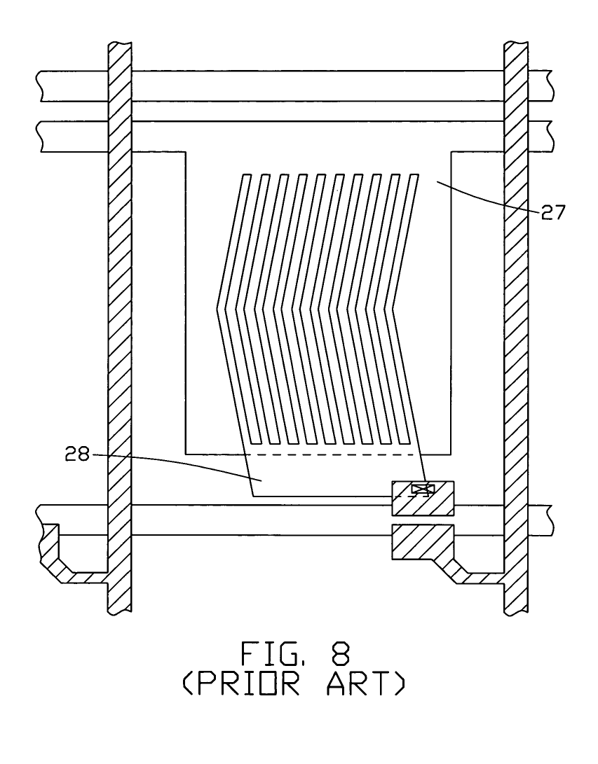

Referring to FIG. 5, this is a top plan view showing a configuration of electrodes of an FFS-LCD device according to a second embodiment of the present invention. The FFS-LCD device has a configuration similar to the FFS-LCD device 200 of the first embodiment. Alignment films thereof cooperatively define two substantially perpendicular aligning directions in each pixel region.

In the illustrated embodiment, each comb tooth portion of the pixel electrodes 333 has an elbow section. That is, the comb tooth portion is rectilinearly bent.

When no voltage is applied to the FFS-LCD device, liquid crystal molecules 351 align in two directions as induced by the alignment films (not shown). Accordingly, the liquid crystal molecules 351 are twisted in different directions so as to compensate for each other in each pixel region, thereby reducing color shift in an off state.

Various modifications and alterations are possible within the ambit of the invention herein. For example, one of the alignment films may be omitted. In such case, a single alignment film is disposed on one of the substrates adjacent to the liquid crystal layer, with the alignment film defining two different aligning directions in each pixel region. Moreover, the curved comb tooth portions of the pixel electrodes may be wavelike, generally “C” shaped, or generally “S” shaped.

It is to be understood, however, that even though numerous characteristics and advantages of the embodiments have been set out in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A fringe field switching liquid crystal display device, comprising:
a first substrate and a second substrate disposed opposite to each other and spaced apart a predetermined distance;
a liquid crystal layer interposed between the first and second substrates;
a plurality of gate lines and data lines formed on the second substrate, thereby defining a plurality of pixel regions;
a plurality of pixel electrodes and a plate-like common electrode provided in each of the pixel regions; and
at least an alignment film disposed at one of the substrates adjacent to the liquid crystal layer, the alignment film defining two aligning directions in each pixel region.

2. The fringe field switching liquid crystal display device as claimed in claim 1, wherein the two aligning directions are substantially perpendicular to each other.

3. The fringe field switching liquid crystal display device as claimed in claim 1, wherein the pixel electrodes include a plurality of comb tooth portions.

4. The fringe field switching liquid crystal display device as claimed in claim 3, wherein the comb tooth portions are arcuate.

5. The fringe field switching liquid crystal display device as claimed in claim 3, wherein each of the comb tooth portions has an elbow section.

6. The fringe field switching liquid crystal display device as claimed in claim 3, wherein the comb tooth portions are wavelike.

7. The fringe field switching liquid crystal display device as claimed in claim 3, wherein the comb tooth portions are generally “C” shaped.

8. The fringe field switching liquid crystal display device as claimed in claim 3, wherein the comb tooth portions are generally “S” shaped.

9. A fringe field switching liquid crystal display device, comprising:
a first substrate and a second substrate disposed opposite to each other and spaced apart a predetermined distance;
a liquid crystal layer interposed between the first and second substrates;
a plurality of gate lines and data lines formed on the second substrate, thereby defining a plurality of pixel regions;
a plurality of pixel electrodes and a plate-like common electrode provided in each of the pixel regions; and
two alignment films disposed at inner surfaces of the first and second substrates respectively, the alignment films cooperatively defining two aligning directions in each pixel region.

10. The fringe field switching liquid crystal display device as claimed in claim 9, wherein the two aligning directions are substantially perpendicular to each other.

11. The fringe field switching liquid crystal display device as claimed in claim 9, wherein the pixel electrodes include a plurality of comb tooth portions.

12. The fringe field switching liquid crystal display device as claimed in claim 9, wherein the comb tooth portions are arcuate.

13. The fringe field switching liquid crystal display device as claimed in claim 9, wherein each of the comb tooth portions has an elbow section.

14. The fringe field switching liquid crystal display device as claimed in claim 9, wherein the comb tooth portions are wavelike.

15. The fringe field switching liquid crystal display device as claimed in claim 9, wherein the comb tooth portions are generally “C” shaped.

16. The fringe field switching liquid crystal display device as claimed in claim 9, wherein the comb tooth portions are generally “S” shaped.

17. A fringe field switching liquid crystal display device comprising:
a first substrate and a second substrate disposed opposite to each other and spaced apart a predetermined distance;
a liquid crystal layer interposed between the first and second substrates;
a plurality of gate lines and data lines formed on the second substrate, thereby defining a plurality of pixel regions;
a plurality of pixel electrodes and a plate-like common electrode provided in each of the pixel regions; and
at least an alignment film disposed at one of the substrates adjacent to the liquid crystal layer; wherein
liquid crystals in the liquid crystal layer are arranged in two different orientations during an off state.
